(19) United States
(12) Patent Application Publication
(10) Pub. No.: US 2024/0405238 A1
(43) Pub. Date: Dec. 5, 2024

(54) FUEL CELL SYSTEM AND METHOD OF OPERATING A FUEL CELL SYSTEM

(71) Applicant: Purem GmbH, Neunkirchen (DE)

(72) Inventor: Gerd Gaiser, Reutlingen (DE)

(21) Appl. No.: 18/678,741

(22) Filed: May 30, 2024

(30) Foreign Application Priority Data
May 30, 2023 (DE) 10 2023 114 075.2

(51) Int. Cl. H01M 8/04746; H01M 8/04119

(52) U.S. Cl. CPC H01M 8/04761; H01M 8/04164; H01M 8/04753; H01M 2250/20

(57) ABSTRACT

A fuel cell system includes a fuel cell having an anode region and a cathode region. The fuel cell defines an anode inlet to permit feeding the anode region with hydrogen and defines a cathode inlet to permit feeding the cathode region with oxygen. The fuel cell has an anode outlet and has a cathode outlet. An anode outlet conduit receives anode offgas at the anode outlet and a catalytic converter is arranged so as to permit the anode offgas in the anode outlet conduit to flow therethrough. A cathode outlet conduit is arranged for receiving cathode offgas at the cathode outlet. A cathode branch conduit connects the cathode outlet conduit to the anode outlet conduit upstream of the catalytic converter.

### CROSS-REFERENCE TO RELATED APPLICATIONS

This application claims priority of German patent application no. 10 2023 114 075.2, filed May 30, 2023, the entire content of which is incorporated herein by reference.

### TECHNICAL FIELD

The present disclosure relates to a fuel cell system that can be utilized, for example, in an electrically operated vehicle to generate the electrical energy required for operation of the vehicle.

### BACKGROUND

In the case of such fuel cell systems having one or more fuel cells in the form of PEM fuel cells, for example, purge operations are conducted to some degree at the start of fuel cell operation and also to some degree during fuel cell operation. In these purge operations, the anode region of a fuel cell is purged with hydrogen which is introduced into the anode inlet region of the fuel cell and released again therefrom at an anode outlet region, such that air and/or nitrogen that accumulate in the anode region are discharged therefrom in order thus to ensure efficient fuel cell operation with unimpaired hydrogen concentration in the anode region.

The hydrogen released from the anode region with the anode offgas in such a purge operation is a fundamentally environmentally harmful gas, and the release of hydrogen to the environment can lead to a potentially critical situation in terms of explosion risk.

### SUMMARY

It is an object of the present disclosure, in a simple and compact construction configuration of a fuel cell system, to reliably minimize the amount of hydrogen released to the environment.

In a first aspect of the present disclosure, this object is achieved by a fuel cell system, especially for a vehicle, including:
at least one fuel cell,
an anode region which is to be fed with hydrogen at an anode inlet region of the at least one fuel cell,
a cathode region which is to be fed with oxygen at a cathode inlet region of the at least one fuel cell,
an anode outlet conduit which accepts anode offgas at an anode outlet region of the at least one fuel cell,
at least one catalyst unit through which the anode offgas can flow in the anode outlet conduit,
a cathode outlet conduit which accepts cathode offgas at a cathode outlet region of the at least one fuel cell,
a cathode branch conduit that connects the cathode outlet conduit to the anode outlet conduit upstream of at least one catalyst unit.

A significant contribution to reduction in the level of hydrogen released to the environment is made by the at least one catalyst unit at which, especially in the case of performance of purge operations, the hydrogen released at the anode outlet region is converted to water in a catalytic reaction with oxygen. The oxygen required for this catalytic conversion is provided in that a portion of the (residual) oxygen-containing cathode offgas which is released at the cathode outlet region is branched off and introduced together with the anode offgas into the at least one catalyst unit or, if two or more such catalyst units are provided, into at least one of the catalyst units.

Since, in the case of the fuel cell system configured in accordance with the disclosure, it is not the whole stream of the cathode offgas that is mixed with the anode offgas, the occurrence of a very low hydrogen concentration in the region of the at least one catalyst unit can be avoided. This avoids the necessity of having to provide the catalyst unit with a large catalyst volume and a large catalyst surface area, via which it is possible to keep firstly build size and secondly build costs low. Secondly, an excessively large mass flow rate through the at least one catalyst unit that leads to a relatively high pressure drop is avoided.

In order to divide the stream of the cathode offgas, the cathode branch conduit may be assigned a flow-directing arrangement for directing a portion of the cathode offgas introduced into the cathode outlet conduit into the cathode branch conduit.

In order to be able to achieve suitable mixing of hydrogen and of oxygen present in the cathode offgas for the catalytic reaction in accordance with purge operations to be conducted in various states of operation or in various phases of operation, the proportion of the cathode offgas introduced into the cathode branch conduit may be variable via the flow-directing arrangement.

In a particularly advantageous configuration, a cathode offgas demoisturizing arrangement may be disposed in the cathode outlet conduit upstream of a branch of the cathode branch conduit from the cathode outlet conduit or/and a cathode offgas demoisturizing arrangement may be disposed in the cathode offgas branch conduit. By virtue of the use of such a demoisturizing arrangement in the form of a condenser unit or water separator, for example, moisture is withdrawn from the portion of the cathode offgas to be mixed with the anode offgas, which firstly has an advantageous effect on the conversion characteristics of the catalyst unit on performance of the catalytic reaction and secondly prevents excessively rapid aging of the catalytically active material in particular.

In the fuel cell system constructed in accordance with the disclosure, a fuel cell offgas system may be provided to accept the portion of the cathode offgas that has not been branched off from the cathode outlet conduit and the mixture of the anode offgas with the portion of the cathode offgas that has been branched off from the cathode outlet conduit, the mixture having been released from the at least one catalyst unit after performance of the catalytic reaction.

For example, the fuel cell offgas system may include a demoisturizing arrangement in order to withdraw further moisture or water from the fuel cell offgas before release to the environment. Alternatively or additionally, the fuel cell offgas system may include a sound absorber in order to suppress the release of noise that may arise, for example, in the region of a compressor that conveys air into the cathode region into the environment.

In a further aspect of the present disclosure, the object is achieved by a method of operating a fuel cell system, especially a fuel cell system constructed in accordance with the disclosure, where anode offgas released at an anode outlet region of a fuel cell is directed through at least one catalyst unit to reduce the hydrogen content in the anode offgas, and a portion of cathode offgas released at a cathode outlet region of a fuel cell is added to the anode offgas upstream of at least one catalyst unit.

For adaptation to various states of operation, the portion of the cathode offgas added to the anode offgas may be variable.

In particular, it may be the case that the amount of the cathode offgas added to the anode offgas is adjusted depending on the hydrogen content in the anode offgas released at the anode outlet region.

For efficient catalytic conversion with minimized volume flow rate through the at least one catalyst unit, it is proposed that the amount of the cathode offgas added to the anode offgas be adjusted such that an at least stoichiometric, preferably superstoichiometric, oxygen/hydrogen ratio is provided for catalytic reaction in the at least one catalyst unit. Especially operation of the at least one catalyst unit with a superstoichiometric oxygen/hydrogen ratio ensures that essentially all the hydrogen present in the anode offgas can be converted to water.

The occurrence of a critical hydrogen concentration with regard to the occurrence of an explosive hydrogen/oxygen gas reaction in the region of the at least one catalyst unit in the mixture of anode offgas and cathode offgas directed through the at least one catalyst unit can be avoided in that the amount of the cathode offgas added to the anode offgas is adjusted such that the mixture of anode offgas and cathode offgas fed to the at least one catalyst unit has a hydrogen content below a threshold hydrogen content.

It is particularly advantageous here when the threshold hydrogen content is in the range from 4% by volume to 8% by volume, and hence an ignition ratio that permits such a reaction is not attained.

For further treatment of the various offgas streams, the portion of the cathode offgas not added to the anode offgas and the mixture of the anode offgas and of the portion of the cathode offgas added to the anode offgas that leaves the at least one catalyst unit after performance of the catalytic reaction are directed into a fuel cell offgas system. In such a fuel cell offgas system, further moisture or further water may be withdrawn from this flowing gas mixture. It is also possible for such a fuel cell offgas system to include a sound absorber in order to suppress the release of noise that may arise in particular in the region of the compressor that conveys air into the cathode region to the outside.

### BRIEF DESCRIPTION OF DRAWINGS

The invention will now be described with reference to the drawings wherein:

FIG. 1 shows a fuel cell system in a schematic representation;

FIG. 2 shows an alternative mode of configuration of the fuel cell system; and,

FIG. 3 shows a further alternative mode of configuration of the fuel cell system.

### DETAILED DESCRIPTION

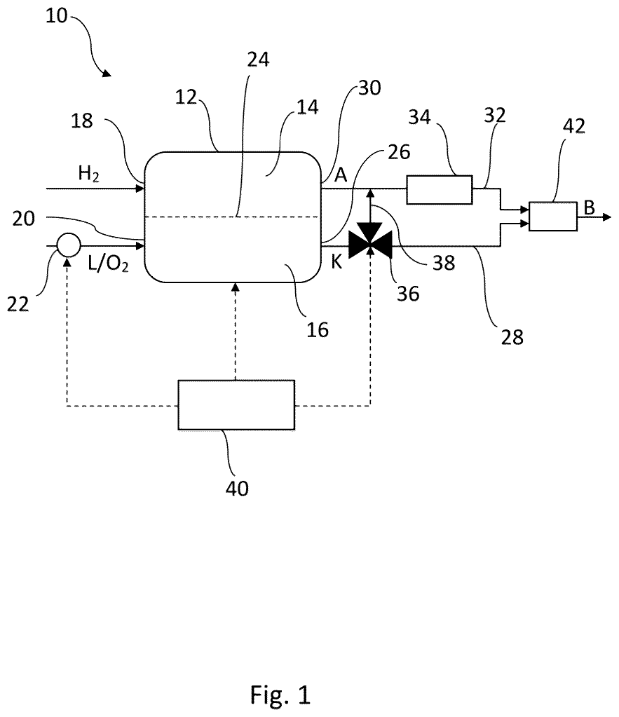

In FIG. 1, a fuel cell system used in a vehicle for generation of electrical energy for example is generally labeled 10. The fuel cell system 10 includes, as central unit, a fuel cell 12 in the form of a PEM fuel cell, for example, or a fuel cell stack, having an anode region 14 and a cathode region 16. The anode region 14 is supplied at an anode inlet region 18 with gaseous hydrogen H₂, for example from a cryogenic hydrogen tank. At a cathode inlet region 20, for example, via a compressor 22, the cathode region 16 is supplied with air L and hence oxygen O₂ present in the air. In fuel cell operation of the fuel cell 12, hydrogen protons diffuse through the membrane 24 of the fuel cell 12 into the cathode region 16, where they react with oxygen introduced into the cathode region 16 to give water, which is released together with residual oxygen and nitrogen present in the air L supplied to the cathode region 16 into a cathode outlet conduit 28 at a cathode outlet region 26.

In order to remove air, that is, essentially oxygen and nitrogen, accumulating in the anode region 14 from the anode region 14 when the fuel cell 12 is not activated, or to discharge nitrogen that accumulates in the anode region 14 via diffusion through the membrane 24 from the anode region 14 during fuel cell operation, purge operations are conducted, for example, before startup of the fuel cell 12 or during fuel cell operation, in which an anode outlet region 30 is opened and the anode region 14 is purged by hydrogen introduced into the anode region 14, or nitrogen and/or oxygen accumulating therein are directed from the anode region 14 via the anode outlet region 30 into an anode outlet conduit 32.

The anode offgas A which is released in particular in such purge operations in the anode outlet conduit 32 contains hydrogen, the release of which to the environment is fundamentally undesirable. For that reason, a catalyst unit 34 is disposed in the anode outlet conduit 32, in which the hydrogen present in the anode offgas A is reacted with oxygen to yield water in a catalytic reaction.

In order to be able to provide the amount of oxygen required for this catalytic reaction, the cathode outlet conduit 28 is assigned a flow-directing arrangement 36 in the form of a valve or flow flap, integrated into the cathode outlet conduit 28 in the configuration example shown. Alternatively, the flow-directing arrangement 36 assigned to the cathode outlet conduit 28 may be integrated into a cathode branch conduit 38 that branches off from the cathode outlet conduit 28 and opens into the anode outlet conduit 32 upstream of the catalyst unit 34. The flow-directing arrangement 36 allows a portion of the cathode offgas K released at the cathode region 16 to be directed into a cathode branch conduit 38, or the cathode branch conduit 38 can be electively opened or shut off.

For defined adjustment of the amount of the cathode offgas K directed via the cathode branch conduit 38 into the anode output conduit 32 and hence also into the catalyst unit 34, the flow-directing arrangement 36 is subject to actuation by an actuation unit 40, which can also be utilized for actuation of the fuel cell 12 itself or the compressor 22.

If a purge operation is to be conducted, it is possible in unchanged operation of the compressor 22, for example, and hence with an unchanged amount of air L introduced into the cathode region 16, to actuate a valve (not shown) assigned to the anode outlet region 30 in order to open it and to allow the anode offgas A to flow into the anode outlet conduit 32. Since the opening of the anode outlet region 30 causes the pressure in the anode region 14 to drop, the conveying output of the compressor 22 can be lowered during such a purge operation in order to maintain uniform pressure conditions. The flow-directing arrangement 36 can be actuated with synchronization to the introduction of the hydrogen-containing anode offgas A into the anode outlet conduit 32 in such a way that a suitable amount of the cathode offgas K is branched off from the cathode outlet conduit 28 and introduced into the anode outlet conduit 32. In order to ensure that there is not at any time too small an amount of oxygen present in the catalyst unit 34 for the performance of the catalytic reaction, it may be the case, for example, that the flow-directing arrangement 36, even before the directing of hydrogen-containing anode offgas A into the anode outlet conduit 32, feeds a portion of the cathode offgas K via the cathode branch conduit 38 into the anode outlet conduit 32 and hence into the catalyst unit 34. With an amount of hydrogen released from the anode region 14 that then increases in the purge operation, a hydrogen/oxygen mixture suitable for complete conversion of the hydrogen is established in the catalyst unit. Since the level of the amount or concentration of hydrogen in the anode offgas A is generally also known, it is also possible to ensure via corresponding actuation of the flow-directing arrangement 36 that the amount of cathode offgas K suitable for the establishment of a defined ratio of hydrogen to oxygen is branched off from the cathode outlet conduit 28.

The first important factor in the performance of the catalytic reaction in the catalyst unit 34 is that essentially no hydrogen that has not reacted with oxygen to give water leaves the catalyst unit 34. This means that the hydrogen/oxygen ratio must be at least stoichiometric. In order to reliably prevent the occurrence of unconverted hydrogen, the oxygen/hydrogen ratio is preferably superstoichiometric, such that the reaction can proceed with an excess of oxygen.

Moreover, it has to be ensured that the percentage by volume of hydrogen in the mixture of anode offgas A and cathode offgas K which is fed to the catalyst unit 34 is sufficiently low that an ignition ratio that entails the risk of a hydrogen/oxygen explosion is not attained. For that reason, it is advantageous when the amount of the cathode offgas K branched off from the cathode offgas K is adjusted such that, taking account of the expected hydrogen content in the anode offgas A in a purge operation, the hydrogen content in the mixture of anode offgas A and cathode offgas K which is then generated does not exceed a threshold hydrogen value in the range from 4% by volume to 8% by volume. It is possible here in particular to determine the amount of the cathode offgas K added to the anode offgas A such that the temperature that arises in the catalyst unit owing to the heat of reaction when the catalytic reaction is in progress lies within an optimal range that assists this reaction.

The anode offgas A leaving the catalyst unit 34, which ideally contains virtually no hydrogen but does contain water, can be fed together with the proportion of the cathode offgas K that has not been branched off from the cathode outlet conduit 28 to a fuel cell offgas system 42, in which, for example, further water can be withdrawn from the mixture of anode offgas A and cathode offgas K that flows through it. It is also possible for the fuel cell offgas system 42 to contain one or more sound absorbers, via which it is then possible to emit the fuel cell offgas B essentially free of hydrogen and with only a comparatively low water content to the environment.

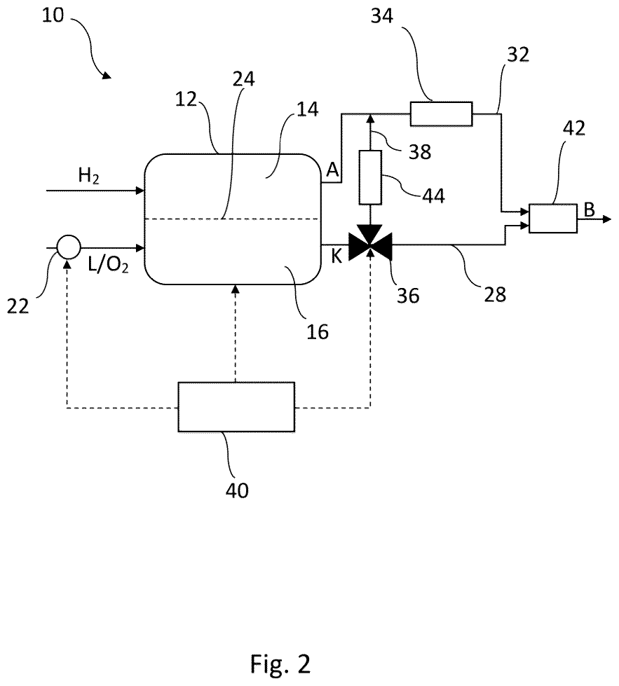

An alternative configuration of the fuel cell system 10 is shown in FIG. 2. In this configuration of the fuel cell system 10, a cathode offgas demoisturizing arrangement 44 is provided in the cathode branch conduit 38 downstream of the flow-directing arrangement 36. This may include, for example, a condenser or a water separator in order to draw off at least a portion of the water transported in the cathode offgas K. The effect of this is that the water content or relative moisture content of the mixture of anode offgas A and cathode offgas K fed to the catalyst unit 34 is reduced, which increases the efficiency of the catalyst unit 34 and prevents excessively severe aging thereof.

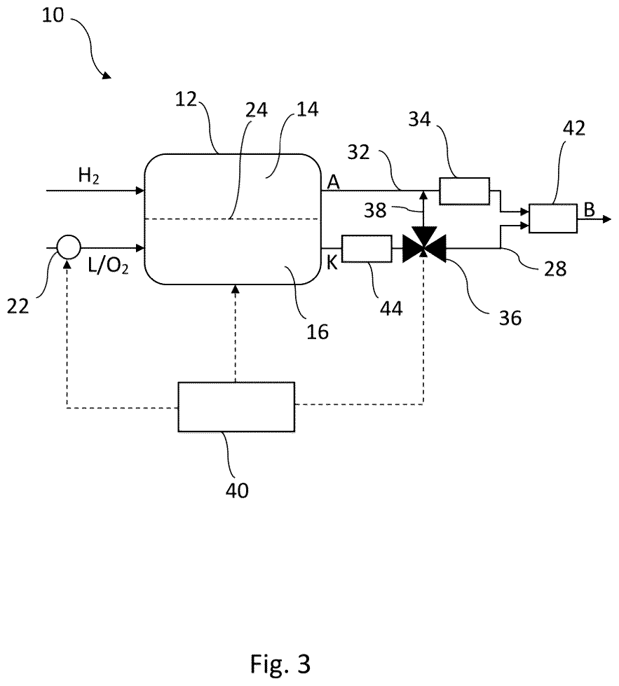

In a further alternative configuration of the fuel cell system as shown in FIG. 3, the cathode offgas demoisturizing arrangement 44 is disposed upstream of the flow-directing arrangement 36 in the cathode outlet conduit 28.

The fuel cell system of the disclosure, with its simple configuration in terms of construction, reliably ensures that hydrogen emitted especially during purge operations from the anode region of one or more fuel cells can be converted reliably to water in a catalytic reaction with oxygen. Since the anode offgas is mixed only with a portion of the cathode offgas, the volume flow rate put through the catalyst unit is comparatively small, which also contributes to a smaller and hence less costly construction of the catalyst unit. Since, moreover, a sufficiently high concentration of hydrogen can be provided for the catalytic conversion, this leads to a greater adiabatic temperature increase and hence to a higher reaction rate, which can increase the efficiency of the catalyst unit.

It is understood that the foregoing description is that of the preferred embodiments of the invention and that various changes and modifications may be made thereto without departing from the spirit and scope of the invention as defined in the appended claims.

1. A fuel cell system comprising:
a fuel cell having an anode region and a cathode region;
said fuel cell defining an anode inlet to permit feeding said anode region with hydrogen;
said fuel cell defining a cathode inlet to permit feeding said cathode region with oxygen;
said fuel cell having an anode outlet and having a cathode outlet;
an anode outlet conduit for receiving anode offgas at said anode outlet;
a catalytic converter arranged so as to permit said anode offgas in said anode outlet conduit to flow therethrough;
a cathode outlet conduit arranged for receiving cathode offgas at said cathode outlet; and,
a cathode branch conduit connecting said cathode outlet conduit to said anode outlet conduit upstream of said catalytic converter.

2. The fuel cell system of claim 1, further comprising: a flow-directing unit assigned to said cathode branch conduit for directing a first portion of said cathode offgas into said cathode branch conduit thereby leaving a remainder portion of said cathode offgas not branched off from said cathode outlet conduit.

3. The fuel cell system of claim 2, wherein the portion of said cathode offgas introduced into said cathode branch conduit is variable via said flow-directing unit.

4. The fuel cell system of claim 1, further comprising:
a cathode offgas demoisturizing unit arranged in accordance with at least one of the following:
i) in said cathode outlet conduit upstream of a branch of said cathode branch conduit from said cathode outlet conduit; and,
ii) in said cathode branch conduit.

5. The fuel cell system of claim 2, further comprising: a fuel cell offgas system for receiving said remainder portion of said cathode offgas and for receiving a mixture of said anode offgas with said first portion of said cathode offgas with said mixture having been released from said catalytic converter after performance of a catalytic reaction.

6. The fuel cell system of claim 5, wherein said fuel cell offgas system includes a demoisturizing unit or/and a muffler.

7. The fuel cell system of claim 1, wherein said fuel cell system is for a vehicle.

8. A method of operating a fuel cell system including: a fuel cell having an anode region and a cathode region; said fuel cell defining an anode inlet to permit feeding said anode region with hydrogen; said fuel cell defining a cathode inlet to permit feeding said cathode region with oxygen; said fuel cell having an anode outlet and having a cathode outlet; an anode outlet conduit for receiving anode offgas at said anode outlet; a catalytic converter arranged so as to permit said anode offgas in said anode outlet conduit to flow therethrough; a cathode outlet conduit arranged for receiving cathode offgas at said cathode outlet; and, a cathode branch conduit connecting said cathode outlet conduit to said anode outlet conduit upstream of said catalytic converter, the method comprising:
directing said anode offgas released at said anode outlet of said fuel cell through said catalytic converter to reduce the hydrogen content in said anode offgas; and,
adding a portion of said cathode offgas released at said cathode outlet to said anode offgas upstream of said catalytic converter.

9. The method of claim 8, wherein the portion of the cathode offgas added to the anode offgas is variable.

10. The method of claim 9, wherein the amount of the cathode offgas added to the anode offgas is adjusted depending on the hydrogen content in the anode offgas released at the anode outlet.

11. The method of claim 9, wherein the amount of the cathode offgas added to the anode offgas is adjusted such that an at least stoichiometric oxygen/hydrogen ratio is provided for catalytic reaction in said catalytic converter.

12. The method of claim 9, wherein the amount of the cathode offgas added to the anode offgas is adjusted such that an at least superstoichiometric oxygen/hydrogen ratio is provided for catalytic reaction in said catalytic converter.

13. The method of claim 11, wherein the amount of the cathode offgas added to the anode offgas is adjusted such that the mixture of anode offgas and cathode offgas supplied to said catalytic converter has a hydrogen content below a threshold hydrogen content.

14. The method of claim 13, wherein the threshold hydrogen content lies in a range from 4% by volume to 8% by volume.

15. The method of claim 8, wherein the portion of the cathode offgas not added to the anode offgas and the mixture of the anode offgas and of the portion of the cathode offgas added to the anode offgas that leaves said catalytic converter after performance of the catalytic reaction are directed into a fuel cell offgas system.

16. The method of claim 8, wherein said fuel cell system is for a vehicle.
